(19) United States
(12) Patent Application Publication
(10) Pub. No.: US 2017/0108798 A1
(43) Pub. Date: Apr. 20, 2017

(54) ACCOMMODATING CONTAINER, CLEANING DEVICE, DEVELOPING DEVICE, PROCESS CARTRIDGE, AND IMAGE FORMING APPARATUS

(71) Applicant: CANON KABUSHIKI KAISHA, Tokyo (JP)

(72) Inventors: Naoki Maeda, Suntou-gun (JP); Noriyuki Komatsu, Numazu-shi (JP); Naoki Matsumaru, Suntou-gun (JP); Ryuta Murakami, Suntou-gun (JP); Takatoshi Hamada, Mishima-shi (JP); Hiroaki Nosho, Suntou-gun (JP)

(21) Appl. No.: 15/288,038

(22) Filed: Oct. 7, 2016

(30) Foreign Application Priority Data
Oct. 14, 2015 (JP) 2015-202501

(51) Int. Cl. G03G 21/12

(52) U.S. Cl. CPC G03G 15/0865; G03G 15/095; G03G 15/0891

(57) ABSTRACT

An accommodating container for accommodating a developer includes a feeding member for feeding the developer in the accommodating container; and a wall member provided in the accommodating container and extending along a direction crossing a developer feeding direction of the feeding member and inclined so that a distance from the feeding member increases toward a downstream side of the feeding member with respect to the developer feeding direction.

### FIELD OF THE INVENTION AND RELATED ART

The present invention relates to an accommodating container, a cleaning device, a developing device, a process cartridge, and an image forming apparatus.

Here, the accommodating container is a container for accommodating a developer for use with the image forming apparatus.

Further, the process cartridge is such a cartridge that an image bearing member such as an electrophotographic photosensitive drum is at least provided and that the image bearing member and a process means actable on the image bearing member are integrally provided. Such a process cartridge is detachably mounted in a main assembly of the image forming apparatus. For example, it is possible to cite a process cartridge prepared by integrally assembling the electrophotographic photosensitive drum and, as the process means, at least one of a developing means, a charging means and a cleaning means into a cartridge.

Further, an electrophotographic image forming apparatus forms an image on a recording material (medium) using an electrophotographic image forming method. Examples of the electrophotographic image forming apparatus may include an electrophotographic copying machine, an electrophotographic printer (LED printer, laser beam printer or the like), a facsimile machine, a word processor, and so on.

In the electrophotographic image forming apparatus, in general, a drum-shaped electrophotographic photosensitive member, i.e., a photosensitive drum as an image bearing member is electrically charged uniformly. Then, the charged photosensitive drum is selectively exposed to light, so that an electrostatic latent image is formed on the photosensitive drum. Then, the electrostatic latent image formed on the photosensitive drum is developed as a toner image with a toner as a developer. Then, the toner image formed on the photosensitive drum is transferred onto the recording material such as a recording sheet or a plastic sheet, and then the toner image transferred on the recording material is subjected to application of heat and pressure and thus is fixed on the recording material to effect image recording.

Such an image forming apparatus requires toner supply and maintenance of various process means in general. In order to facilitate the toner supply and the maintenance, a process cartridge in which the photosensitive drum, the charging means, the developing means, the cleaning means and the like are integrally assembled into a cartridge in a single frame is made detachably mountable to an image forming apparatus main assembly and has been put into practical use.

According to this process cartridge type, the maintenance of the devices can be made by a user himself (herself), and therefore operativity can be remarkably improved, so that it is possible to provide an image forming apparatus excellent in usability. For that reason, the process cartridge type has been widely used in the image forming apparatus.

The process cartridge described above includes a toner accommodating chamber for accommodating a residual toner generating by scraping off the toner, which has not been fixed on the recording material, with a cleaning means. As a method of accommodating the toner in the toner accommodating chamber, a constitution using a screw and a partition wall has been known (Japanese Laid-Open Patent Application (JP-A) 2011-242524).

However, in recent years, an increase in capacity and lifetime extension of the process cartridge has been required. Particularly, as in the constitution disclosed in JP-A 2011-242524, in a type in which the toner accommodating chamber is partitioned by the partition wall perpendicular to the screw for feeding the toner with respect to a toner feeding direction, the toner cannot be accommodated in an entirety of a broad toner accommodating chamber. Further, when the toner in a large amount is accommodated in the toner accommodating chamber, there is a possibility that the toner stagnates at an intermediary position and breaks the screw due to its load.

### SUMMARY OF THE INVENTION

A principal object of the present invention is to provide an accommodating container, a cleaning device, a developing device, a process cartridge, and an image forming apparatus in which a developer can be accommodated in an entirety of an accommodating portion without exerting an excessive load on a feeding member for feeding the developer.

According to an aspect of the present invention, there is provided an accommodating container for accommodating a developer, comprising: a feeding member for feeding the developer in the accommodating container; and a wall member provided in the accommodating container and extending along a direction crossing a developer feeding direction of the feeding member and inclined so that a distance from the feeding member increases toward a downstream side of the feeding member with respect to the developer feeding direction.

Further features of the present invention will become apparent from the following description of exemplary embodiments with reference to the attached drawings.

### BRIEF DESCRIPTION OF THE DRAWINGS

In FIG. 1, (a) and (b) are sectional views each showing a relationship between a third wall and a partition wall in a residual toner chamber as an accommodating container according to First Embodiment of the present invention.

FIG. 2 is a sectional view showing a main assembly of an image forming apparatus in which the accommodating container in First Embodiment is mounted and showing a process cartridge.

FIG. 3 is a sectional view of the process cartridge in which the accommodating container in First Embodiment is mounted.

In FIG. 4, (a) is a side view of the process cartridge in which the accommodating container in First Embodiment is mounted, and (b) is a sectional view showing an inside of a cleaning frame.

FIG. 5 is a perspective view of the image forming apparatus main assembly in a state in which an openable door of the image forming apparatus in which the accommodating container in First Embodiment is mounted is open.

FIG. 6 is a perspective view of the image forming apparatus main assembly in a state in which the openable door of the image forming apparatus in which the accommodating container in First Embodiment is mounted is opened and then a tray is pulled out.

FIG. 7 is a perspective view of the image forming apparatus main assembly and the process cartridge when the process cartridge is mounted in and demounted from the tray in the state in which the openable door of the image forming apparatus in which the accommodating container in First Embodiment is mounted is opened and then the tray is pulled out.

FIG. 8 is a perspective view showing a driving side positioning portion between the process cartridge and the image forming apparatus main assembly in a state in which the process cartridge is mounted in the image forming apparatus main assembly in the image forming apparatus in which the accommodating container in First Embodiment is mounted.

FIG. 9 is a perspective view showing a non-driving side positioning portion between the process cartridge and the image forming apparatus main assembly in the state in which the process cartridge is mounted in the image forming apparatus main assembly in the image forming apparatus in which the accommodating container in First Embodiment is mounted.

FIG. 10 is a general perspective view of the process cartridge in which the accommodating container in First Embodiment is mounted as seen from a non-driving side.

FIG. 11 is a partial perspective view of the process cartridge in which the accommodating container in First Embodiment is mounted as seen from the non-driving side.

FIG. 12 is a general perspective view of the process cartridge in which the accommodating container in First Embodiment is mounted as seen from the non-driving side.

FIG. 13 is a partial perspective view of the process cartridge in which the accommodating container in First Embodiment is mounted as seen from a driving side.

In FIG. 14, (a) and (b) are sectional views each showing a relationship between a third screw and a partition wall in an accommodating container according to Second Embodiment.

In FIG. 15, (a) and (b) are schematic views each showing a relationship between a third screw and a wall in an accommodating container according to Third Embodiment.

### DESCRIPTION OF THE EMBODIMENTS

Embodiments of the present invention will be described in detail with reference to the drawings. In the following description, a rotational axis direction of a photosensitive drum is a longitudinal direction. Further, with respect to the longitudinal direction, a side in which the photosensitive drum receives a driving force from an apparatus main assembly of an image forming apparatus is a driving side, and an opposite side thereof is a non-driving side.

### First Embodiment

### (General Structure of Image Forming Apparatus)

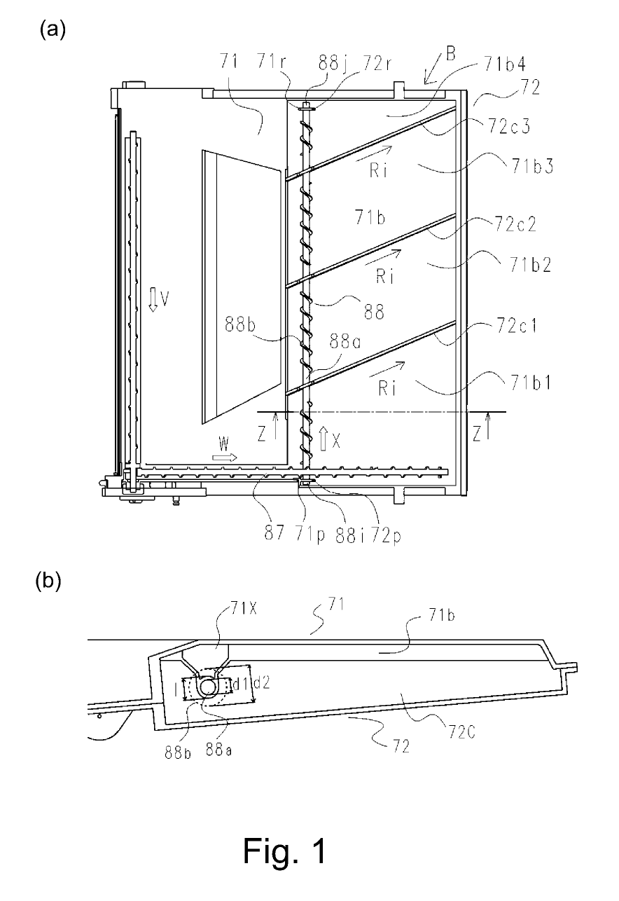

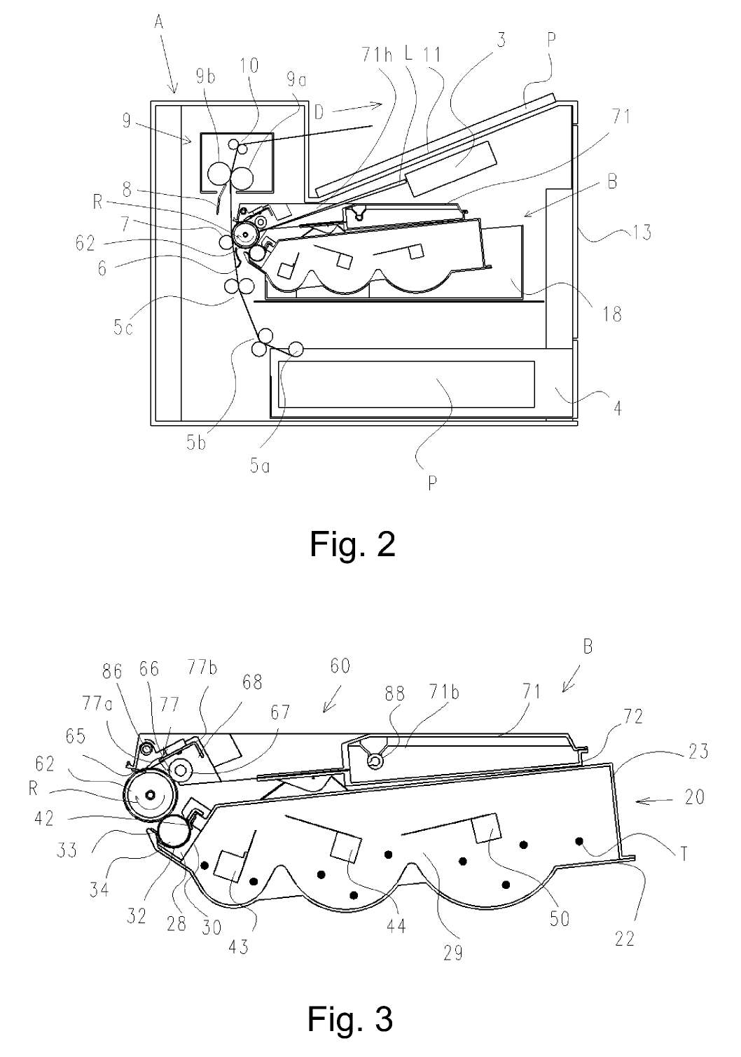

FIG. 2 is a sectional view showing a main assembly of an image forming apparatus 1 (hereinafter referred to as an apparatus main assembly A) in which an accommodating container according to this embodiment is mounted and showing a process cartridge (hereinafter referred to as a cartridge B. The apparatus main assembly A is a portion from which the cartridge B is removed.

The image forming apparatus shown in FIG. 2 is a laser beam printer using electrophotography in which the cartridge B is detachably mountable to the apparatus main assembly A. When the cartridge B is mounted in the apparatus main assembly A, an exposure device (laser scanner unit) 3 for forming an electrostatic latent image on an electrophotographic photosensitive drum (hereinafter referred to as a drum) 62 of the cartridge B is provided. Further, below the cartridge B, a sheet (feeding) tray 4 in which a recording material or medium (hereinafter referred to as a sheet material) P to be subjected to image formation is accommodated is provided.

Further, in the apparatus main assembly A, along a feeding direction D of the sheet material P, a pick-up roller 5a, a feeding roller pair 5b, a conveying roller pair 5c, a transfer guide 6, a transfer roller 7, a feeding guide 8, a fixing device 9, a discharging roller pair 10, a discharge tray 11 and the like are successively provided. The fixing device 9 is constituted by a heating roller 9a and a pressing roller 9b.

### (Image Forming Process)

An outline of an image forming process will be described using FIGS. 2 and 3. FIG. 3 is a sectional view of the cartridge B.

As shown in FIG. 2, on the basis of a print start signal, the drum 62 is rotationally driven an a predetermined peripheral speed (process speed) in an arrow R direction. Then, as shown in FIG. 3, a charging roller 66 to which a bias voltage is applied contacts the outer peripheral surface of the drum 62 and electrically charges the outer peripheral surface of the drum 62 uniformly.

The exposure device 3 outputs laser light L depending on image information as shown in FIG. 2. The laser light L passes through a laser opening 71h provided in a cleaning frame 71, so that the outer peripheral surface of the drum 62 is subjected to scanning exposure. As a result, on the outer peripheral surface of the drum 62, the electrostatic latent image depending on the image information is formed.

On the other hand, as shown in FIG. 3, a toner T in a toner chamber 29 provided in a developing unit 20 as a developing device is stirred and fed by rotation of a first stirring member 43, a second stirring member 44 and a third stirring member 50, thus being sent to a toner supplying chamber 28. The toner T is carried by a magnetic force of a magnet roller 34 (fixed magnet) on a surface of a developing roller 32. The toner T is regulated in layer thickness on the peripheral surface of the developing roller 32 by a developing blade 42 as a collecting member for collecting the developer while being triboelectrically charged. Thereafter, the toner T is supplied onto the drum 62 depending on the electrostatic latent image, so that the electrostatic latent image is visualized (developed) as a toner image.

As shown in FIG. 2, in synchronism with output timing of the laser light L, by the pick-up roller 5a, the feeding roller pair 5b and the conveying roller pair 5c, the sheet material P accommodated in the sheet tray 4 provided at a lower portion of the apparatus main assembly A is fed from the sheet tray 4. Then, the sheet material P is fed to a transfer position between the drum 62 and the transfer roller 7 via the transfer guide 6. In this transfer position, the toner image is successively transferred from the drum 62 onto the sheet material P.

The sheet material P on which the toner image is transferred is separated from the drum 62 and then is fed to the fixing device 9 along the conveying guide 8. Then, the sheet material P passes through a nip between the heating roller 9a and the pressing roller 9b which constitute the fixing device 9. At this nip, a pressure and heat-fixing process is effected, so that the toner image is fixed on the sheet material P. The sheet material P on which the toner image is fixed is fed to the discharging roller pair 10 and then is discharged onto the discharge tray 11 in an arrow D direction.

On the other hand, as shown in FIG. 3, from the drum 62 after the transfer, a residual toner remaining on the outer peripheral surface of the drum 62 is removed by a cleaning blade 77, and the drum 62 is used again in the image forming process. The residual toner removed from the drum 62 is stored in a residual toner chamber 71b of a cleaning unit 60.

### (Mounting and Demounting of Cartridge Relative to Apparatus Main Assembly)

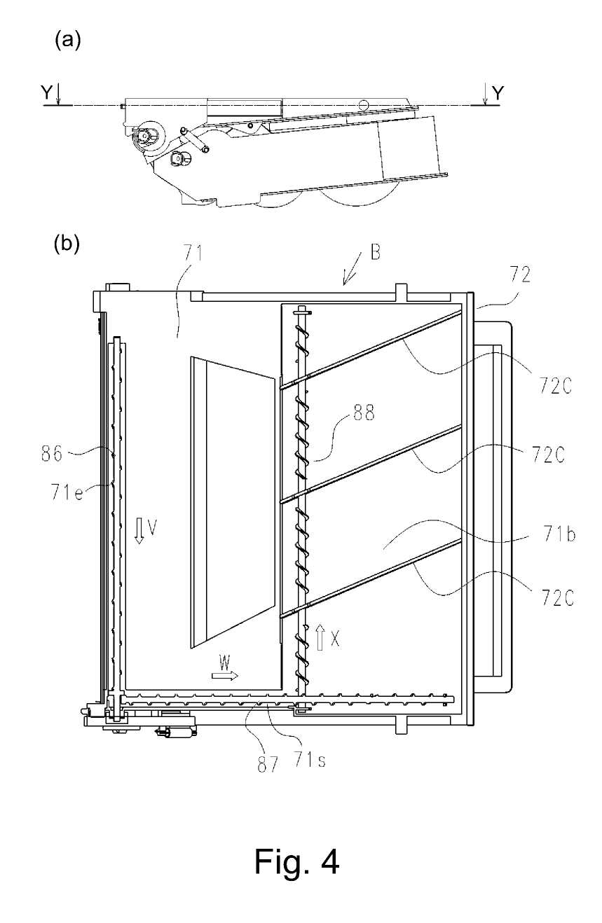

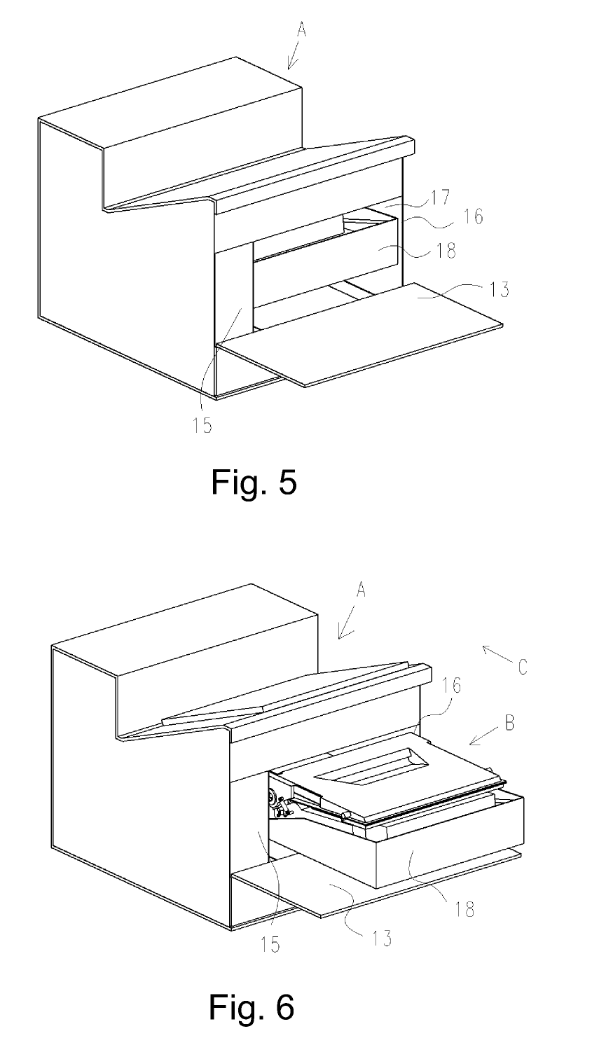

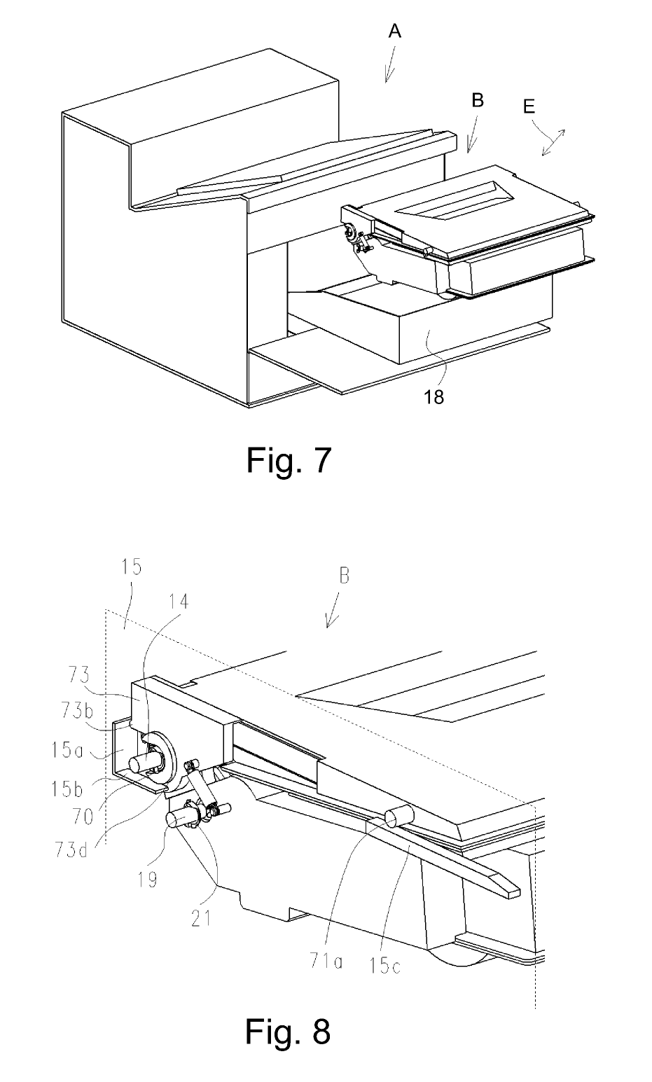

Next, mounting and demounting of the cartridge B will be described using FIGS. 5 to 8. FIG. 5 is a perspective view of the apparatus main assembly A of which an openable door 13 is opened for permitting mounting and demounting of the cartridge B. FIG. 6 is a perspective view of the apparatus main assembly A and the cartridge B in a state in which the openable door 13 is opened for permitting the mounting and demounting of the cartridge B and then a tray 18 is pulled out. FIG. 7 is a perspective view of the apparatus main assembly A and the cartridge B when the cartridge B is demounted and mounted in a state in which the openable door 13 is opened and then the tray 18 is pulled out. FIG. 8 is a perspective view of a driving side positioning portion between the cartridge B and the apparatus main assembly A in a state in which the cartridge B is mounted in the apparatus main assembly A.

As shown in FIG. 5, to the apparatus main assembly A, the openable door 13 is rotatably attached, and when the openable door 13 is opened, a cartridge inserting opening 17 is exposed. In the cartridge inserting opening 17, a tray 18 for mounting the cartridge B in the apparatus main assembly A is provided. As shown in FIG. 6, when the tray 18 is pulled out to a predetermined position, the cartridge B can be mounted and demounted. The cartridge B is inserted (mounted) in the apparatus main assembly A along a guide rail (not shown) in an arrow C direction in FIG. 6 in a state in which the cartridge B is placed on the tray 18. The mounting and demounting of the cartridge B relative to the tray 18 are made along an arrow E direction in FIG. 7.

The apparatus main assembly A is provided with a first driving shaft 14 and a second driving shaft 19 as shown in FIG. 8. The first driving shaft 14 transmits a driving force to a first coupling 70 of the cartridge B. The second driving shaft 19 transmits a driving force to a second coupling 21. The first driving shaft 14 and the second driving shaft 19 are driven by a motor (not shown) of the apparatus main assembly A. As a result, the drum 62 connecting with the first coupling 70 receives the driving force from the apparatus main assembly A and is rotated.

The developing roller 32 is rotated by transmission of the driving force from the second coupling 21. Further, to the charging roller 66 and the developing roller 32, a predetermined bias voltage is applied by an electric power supplying portion (not shown) of the apparatus main assembly A.

### (Cartridge Supporting Structure of Apparatus Main Assembly)

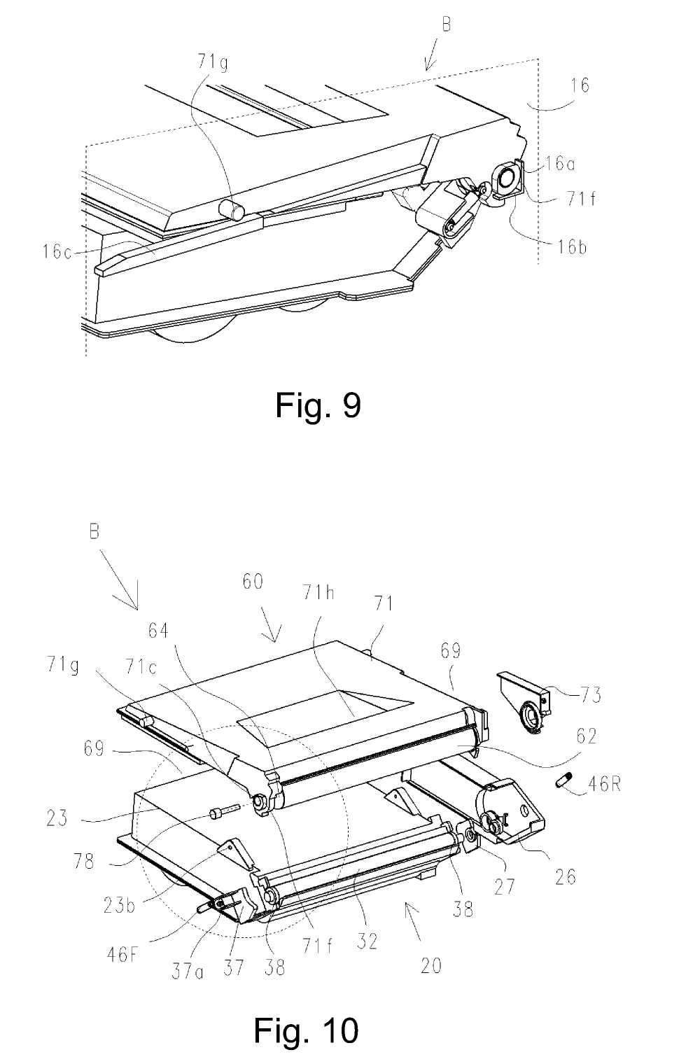

Next, a supporting structure of the cartridge B by the apparatus main assembly A will be described using FIGS. 5, 8 and 9. FIG. 5 is a perspective view of the apparatus main assembly A of which an openable door 13 is opened for permitting mounting and demounting of the cartridge B. FIG. 8 is a perspective view of a driving side positioning portion between the cartridge B and the apparatus main assembly A in a state in which the cartridge B is mounted in the apparatus main assembly A. FIG. 9 is a perspective view of a non-driving side positioning portion between the cartridge B and the apparatus main assembly A in a state in which the cartridge B is mounted in the apparatus main assembly A.

As shown in FIG. 5, the apparatus main assembly A is provided with a driving side-side plate 15 and the non-driving side-side plate 16 for supporting the cartridge B. As shown in FIG. 8, the driving side-side plate 15 is provided with a driving side-first supporting portion 15a, a driving side-second supporting portion 15b and a rotation supporting portion 15c for the cartridge B. As shown in FIG. 9, the non-driving side-side plate 16 is provided with a non-driving side-first supporting portion 16a, a non-driving side-second supporting portion 16b and a rotation supporting portion 16c for the cartridge B.

On the other hand, as driving side portions-to-be-supported of the cartridge B, a portion-to-be-supported 73b and a portion-to-be-supported 73d of a drum bearing 73, and a driving side boss 71a are provided as shown in FIG. 8. The portion-to-be-supported 73b is supported by the driving side-first supporting portion 15a, the portion-to-be-supported 73d is supported by the driving side-second supporting portion 15b, and the driving side boss 71a is supported by the rotation supporting portion 15c. Further, as non-driving side portions-to-be-supported, as shown in FIG. 9, a non-driving side projection 71f and a non-driving side boss 71g are provided. The non-driving side projection 71f is supported by the non-driving side-first supporting portion 16a and the non-driving side-second supporting portion 16b, and the non-driving side boss 71g is supported by the rotation supporting portion 16c. By the above-described structure, the cartridge B is positioned inside the apparatus main assembly A.

### (General Structure of Cartridge)

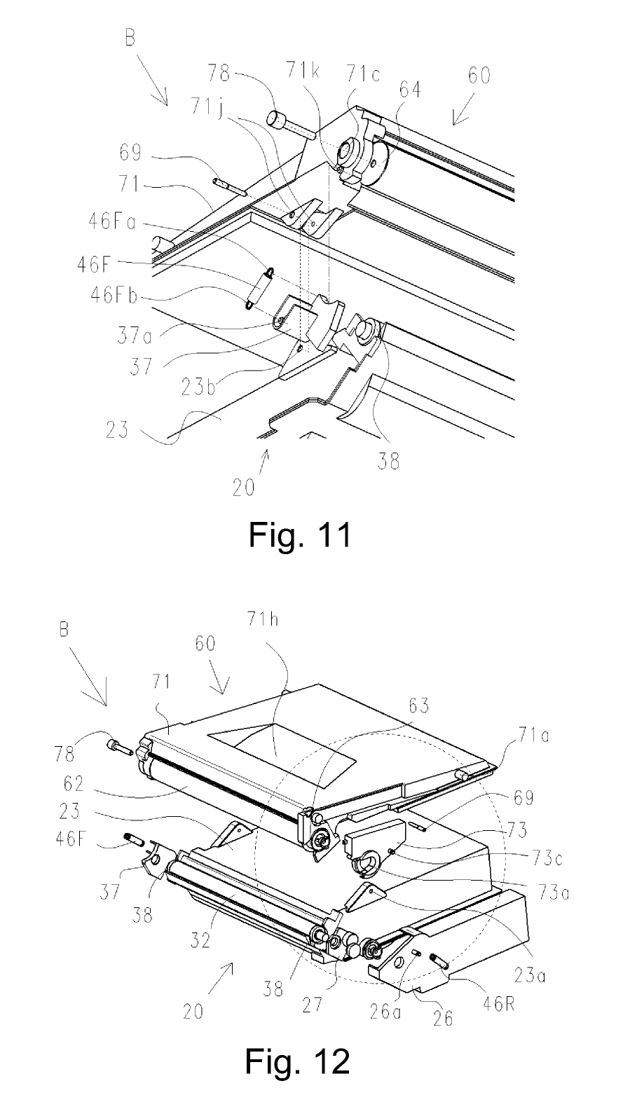

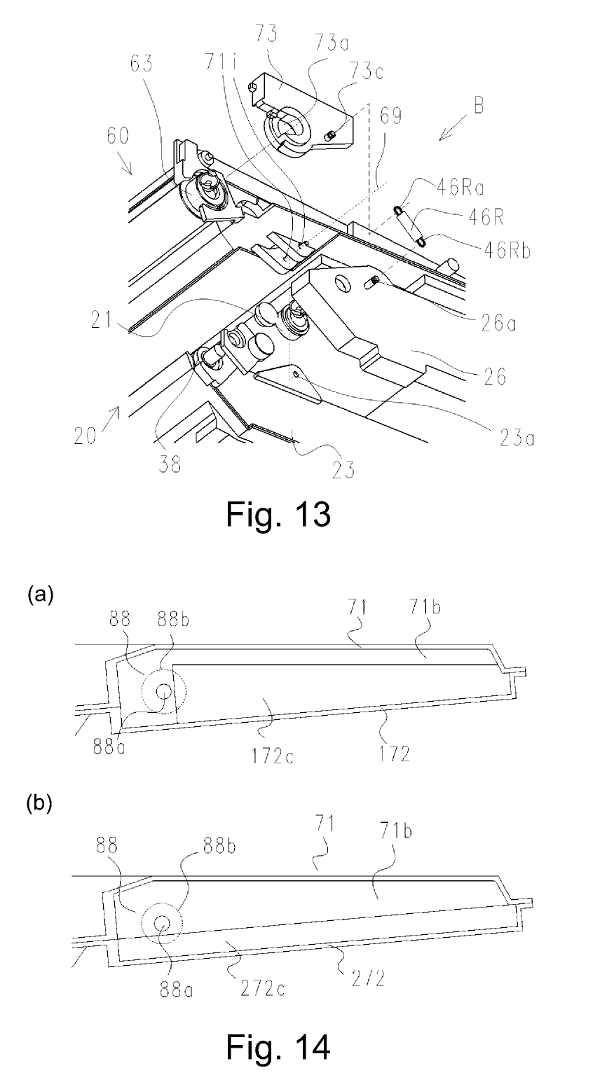

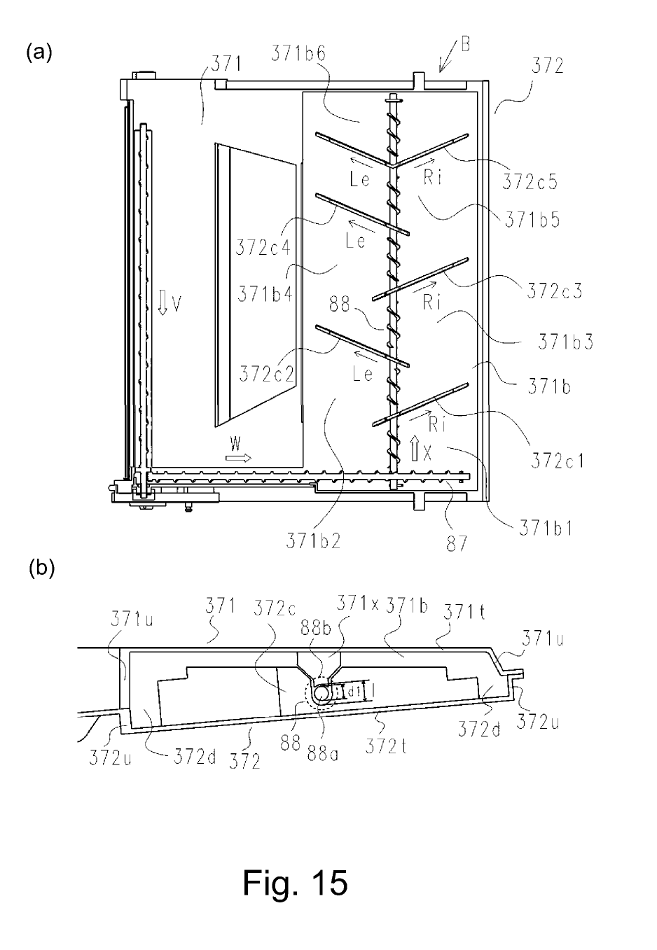

Next, a general structure of the cartridge B will be described with reference to FIGS. 3, 4 and 10-13. FIG. 3 is a sectional view of the cartridge B. In FIG. 4, (a) is a side view of the cartridge B, and (b) is a sectional view showing an inside of the cleaning frame 71. FIG. 10 is a general perspective view of the cartridge B as seen from the non-driving side. FIG. 11 is a general perspective view of the cartridge B as seen from the non-driving side. FIG. 2 is a general perspective view of the cartridge B as seen from the driving side. FIG. 13 is a partial perspective view of the cartridge B as seen from the driving side.

In FIG. 4, (a) is the side vie of the cartridge B as seen from the driving side, and (b) is the sectional view showing the inside of the cleaning frame 71 as seen in an arrow Y direction in (a) of FIG. 4. FIG. 11 is an enlarged view showing an inside of a dotted circle of FIG. 10 (but an angle thereof is changed). FIG. 13 is an enlarged view showing an inside of a dotted circle of FIG. 12 (but an angle thereof is changed). In this embodiment, screws used when respective parts (components) are connected will be omitted from illustration.

The cartridge B is formed by the cleaning unit 60 and the developing unit 20 as shown in FIG. 3. The cleaning unit 60 includes the drum 62, the charging roller 66 and the cleaning member 77, and these members are supported by the cleaning frame 71. Further, to the cleaning frame 71, a cleaning cover 72 is fixed by welding or the like. Further, each of the charging roller 66 and the cleaning member 77 is disposed in contact with the outer peripheral surface of the drum 62.

In FIG. 3, the cleaning member 77 is formed by a rubber blade 77a which is a blade-shaped elastic member and a supporting member 77b for supporting the rubber blade 77a. The rubber blade 77a contacts the drum 62 counterdirectionally to a rotational direction of the drum 62. That is, the rubber blade 77a contacts the drum 62 so that a free end portion thereof faces toward an upstream side with respect to the rotational direction of the drum 62.

A residual toner (waste toner) removed from the surface of the drum by the cleaning member 77 is sequentially fed in the following manner. That is, as shown in (b) of FIG. 4, the residual toner is fed in directions of arrows V, W and X in a listed order by a first screw 86, a second screw (first feeding member) 87 and a third downstream (second feeding member) 88, respectively, as a residual toner feeding member. The residual toner is fed in the order of a cleaning chamber 71e and a residual toner feeding path 71s as shown in (b) of FIG. 4, and then is stored in a residual toner chamber 71b ((b) of FIG. 4), as an accommodating member (accommodating portion) for accommodating the developer (residual toner), formed by the cleaning frame 71 and the cleaning cover 72.

The first screw 86 is rotated by transmitting a driving force, received from the apparatus main assembly A by the cartridge B, through a gear (not shown) or the like. The second screw 87 is rotated by receiving the driving force from the first screw 86. The third screw 88 is rotated by receiving the driving force from the second screw 87. The first screw 86 is disposed in the neighborhood of the drum 62. The second screw 87 is disposed at a longitudinal end portion of the cleaning frame 71. The third screw 88 is disposed in the residual toner chamber 71b.

A rotational axis of the first screw 86 and a rotational axis of the third screw 88 are parallel to a rotational axis of the drum 62. A rotational axis of the second screw 87 is substantially perpendicular to the rotational axis of the photosensitive drum 62. An arrangement of the screws as a residual toner feeding means will be described later in detail.

In FIG. 3, a receptor sheet 65 for preventing the residual toner from leaking out of the cleaning frame 71 is provided at an end portion of the cleaning frame 71 so as to contact the drum 62. The drum 62 is rotationally driven in the arrow R direction in FIG. 3 depending on an image forming operation by receiving the driving force from a main assembly driving motor (not shown) which is a driving source.

The charging roller 66 is rotatably mounted to the cleaning unit 60 via charging roller bearings (not shown) at end portions thereof with respect to a longitudinal direction of the cleaning frame 71 (substantially parallel to a rotational axis direction of the drum 62). The charging roller 66 is press-contacted to the drum 62 by pressing the charging roller bearings toward the drum 62 by urging members (not shown). The charging roller 66 is rotated by rotation of the drum 62.

In FIG. 3, the developing unit 20 includes the developing roller 32 and the developing blade 42. The developing roller 32 and the developing blade 42 are supported by a developing container as the accommodating member for accommodating the developer. To the developing container 23, a bottom member 22 is fixed by welding or the like, whereby the toner supplying chamber 28 and the toner chamber 29 are formed. The toner supplying chamber 28 and the toner chamber 29 communicate with each other through a toner supply opening 30.

The developing roller 32 is a hollow member, and inside thereof, a magnet roller 34 is provided. The developing blade 42 regulates a toner layer (thickness) on the developing roller 32. As shown in FIG. 10, a gap-keeping member 38 is mounted to the developing roller 32 at each of end portions of the developing roller 32. By contact of the gap-keeping members 38 with the drum 62, the developing roller 32 is held so as to have a predetermined gap with the drum 62.

Further, as shown in FIG. 3, a leaking-out preventing sheet 33 is provided at an edge portion of the bottom member 22 so as to contact the developing roller 32. The leaking-out preventing sheet 33 prevents the toner from leaking out of the developing unit 20.

In the toner chamber 29, a first stirring member 43, a second stirring member 44 and a third stirring member 50 as rotatable members are provided. Each of the first stirring member 43, the second stirring member 44 and the third stirring member 50 rotates in the clockwise direction, and not only stirs the toner accommodated in the toner chamber 29 but also feeds the toner to the toner supplying chamber 28.

The cleaning unit 60 includes, as shown in FIG. 12, the drum bearing 73 and a drum shaft 78. As shown in FIG. 13, on the driving side of the drum 62, a driving side drum flange 63 provided on the driving side is rotatably supported by a hole 73a of the drum bearing 73. In the non-driving side, as shown in FIG. 11, the drum shaft 78 press-fitted in a hole 71c provided in the cleaning frame 71 rotatably supports a hole (not shown) of a non-driving side drum flange 64.

On the other hand, as shown in FIGS. 10 and 12, in the developing unit 20, by bearing members 27 and 37 provided at end portions of the developing roller 32, the developing roller 32 is rotatably supported.

As shown in FIGS. 11 and 13, connection between the cleaning unit 60 and the developing unit 20 are made by rotatably connecting the cleaning unit 60 and the developing unit 20 by connecting pins 69 relative to each other. Specifically, in the driving side of the developing unit 20, as shown in FIG. 13, a developing-first supporting hole 23a is provided as a part of the developing container 23. In the non-driving side, as shown in FIG. 11, a developing-second supporting hole 23b is provided as a part of the developing container 23.

Further, in the driving side of the cleaning unit 60, as shown in FIG. 13, first hanging holes 71i are provided as a part of the cleaning frame 71. In the non-driving side, as shown in FIG. 11, second hanging holes 71j are provided as a part of the cleaning frame 71. In the driving side, as shown in FIG. 13, the connecting pin 69 press-fitted and fixed in the first hanging holes 71i and the first supporting hole 23a engage with each other. In the non-driving side, as shown in FIG. 11, the connecting pin 69 press-fitted and fixed in the second hanging holes 71j and the second supporting hole 23b engage with each other. By the above-described constitution, the developing unit 20 is rotatably connected with the cleaning unit 60.

Further, as shown in FIG. 13, a first hole 46Ra of a driving side-urging member 46R is hooked on a boss 73c of the drum bearing member 73, and a second hole 46Rb of the driving side-urging member 46R is hooked on a boss 26a of the driving side-developing side member 26. Further, as shown in FIG. 11, a first hole 46Fa of a non-driving side-urging member 46F is hooked on a boss 71k of the cleaning frame 71, and a second hole 46Fb of the non-driving side-urging member 46F is hooked on a boss 37a of the bearing member 37.

As described above, in this embodiment, each of the driving side-urging member 46R and the non-driving side-urging member 46F is formed with a tension spring, and the developing unit 20 is urged toward the cleaning unit 60 by an urging force of these springs, so that the developing roller 32 is pressed toward the drum 62 with reliability.

### (Structure of Residual Toner Chamber)

A structure of the residual toner chamber 71b as the accommodating container for accommodating the developer will be specifically described with reference to (a) and (b) of FIG. 1. In FIG. 1, (a) is a sectional view of the residual toner chamber 71b taken along Y-Y line shown in (a) of FIG. 4, and (b) is a sectional view of the residual toner chamber 71b taken along Z-Z line shown in (a) of FIG. 1. As shown in (a) of FIG. 1, in the residual toner chamber 72b the third screw 88 as the feeding member is rotatably provided, and 3 partition walls 72c (72c1-72c3) which are wall members are provided. In this embodiment, the inside of the residual toner chamber 71b are partitioned into 4 rooms by the 3 partition walls 72c (72c1-72c3).

In (a) of FIG. 1, the third screw 88 is constituted by a screw shaft portion 88a, a helical screw portion 88b, portions-to-be-supported 88i and 88j and a driven portion (not shown), and the screw portion 88b is a left-handed (counterclockwise) helical screw. In (a) and (b) of FIG. 1, the portions-to-be-supported 88i and 88j provided at longitudinal end portions of the third screw 88 are supported by being abutted against two supporting ribs 71p and 72p and two supporting ribs 71r and 72r, respectively, formed by the cleaning frame 71 and the cleaning cover 72.

The third screw 88 is provided below the second screw 87 with respect to gravitational direction, and a driving force is transmitted from drive transmitting portion (not shown) of the second screw 87 to the third screw 88. Further, the partition walls 72c (821-72c3) are disposed inside the residual toner chamber 71b so as to cross the third screw 88, and are disposed at a plurality of positions along a rotational axis direction (arrow X direction) while being inclined in an obliquely rightward direction (hereinafter referred to as an Ri direction). The third screw 88 includes only the screw shaft 88a in each of sections (regions) where the third screw crosses the partition walls 72c (72c1-72c3) and no screw portion 88b is provided.

As shown in (b) of FIG. 1, in combination with the partition walls 72c, an upper partition wall 71x provided on the cleaning frame 71 is disposed above the partition wall 7, so that the residual toner chamber 72b is partitioned. Further, in (b) of FIG. 1, a relationship among a groove diameter l provided by the partition wall 72c and the upper partition wall 72x, a diameter d1 of the screw shaft portion 88a and a diameter d2 of the screw portion 88b is: d2>l>d1.

Thus, the toner fed in the arrow W direction by second screw 87 is delivered to the third screw 88 at a crossing portion between the second screw 87 and the third screw 88 as seen from above. The toner delivered to the third screw 88 is fed in the arrow X direction and abuts against the first partition wall 72c.

At a crossing portion between the third screw 88 and the partition wall 72c, the screw portion 88b is cut away, and the crossing portion is a region consisting only of the screw shaft 88a, and therefore the toner feeding force in the arrow X direction which is the feeding direction lowers. The toner abutting against the first partition wall 72c1 moves along the first partition wall 72c1 and is fed in the Ri direction. The toner fed in the Ri direction is gradually accumulated in a first accommodating chamber 71b1 of the residual toner chamber 71b.

When the first accommodating chamber 71b1 is filled with the toner, the toner fed by the third screw 88 passes through a gap between the groove diameter l, provided by the first partition wall 72c1 and the upper downstream 71x, and the diameter d1 of the screw shaft portion 88a, and is fed to a second accommodating chamber 71b2. Thereafter, a relationship between the first accommodating chamber 71b1 and the second accommodating chamber 71b2 is similarly reproduced also between the second accommodating chamber 71b2 and a third accommodating chamber 71b3, and then the toner is finally accumulated in a fourth accommodating chamber 71b4.

As described above, the toner fed by the third screw 88 is successively filled in the residual toner chamber 71b from an upstream space partitioned by the partition walls 72c (72c1-72c3). Accordingly, in a side downstream of the third screw 88, the toner can be stably accommodated without exerting an excessive load, due to toner packing, on the third screw 88 which feeds the toner. A size of the residual toner chamber 71b is optimized depending on a residual toner amount estimated in a product.

The above-described relationship between the groove diameter l and the diameter d2 of the screw portion 88b may also be: l>d2>d1 at a crossing portion between the groove diameter l and the third screw 88.

In this embodiment, the partition wall 72c extending so as to incline in one side (rightward direction) toward a downstream side with respect to the feeding direction of the third screw 88 was provided, but may also be provided in the other side (leftward direction) with respect to the feeding direction of the third screw 88. Further, in this embodiment, the 3 partition walls 72c were provided to partition the residual toner chamber 71b into 4 rooms, but the number of the partition walls may also be changed to 4 or more, two, or one, so that the residual toner chamber 71b may be partitioned into 5 or more rooms, three rooms, or two room.

### Second Embodiment

Second Embodiment of the present invention will be described with reference to (a) and (b) of FIG. 14. In First Embodiment, the relationship such that the partition wall 72c overlaps with the screw shaft portion 88a of the third screw 88 was established, but in this embodiment, a relationship such that the partition wall overlaps with the screw portion 88b of the third screw 88 is established. In this embodiment, only a portion different from that in First Embodiment will be described by changing a reference numeral or symbol thereof, and materials and shapes of respective portions are similar to those in First Embodiment unless otherwise specified.

In FIG. 14, (a) and (b) are sectional views each showing the residual toner chamber 71b cut at the same position as that in (b) of FIG. 1. As shown in (a) of FIG. 14, a partition wall 172c is provided in a right side of the third screw 88. Further, the partition wall 172c has an overlapping relationship with the screw portion 88b of the third screw 88 with respect to the arrow X direction.

The toner fed by the third screw 88 abuts against an overlapping portion between the partition wall 172c and the screw portion 88b with respect to the arrow X direction. The abutted toner is fed along the partition wall 172c to a place spaced in the residual toner chamber 71b from the third screw 88. Thereafter, as described in First Embodiment, the residual toner chamber 71b is successively filled with the toner from an upstream space partitioned by the partition walls 172c. Accordingly, the toner can be stable accommodated without exerting an excessive load, due to toner packing in a side downstream of the third screw 88, on the third screw 88 which feeds the toner.

In (a) of FIG. 14, the partition wall 172c was disposed in an upper side of the third screw 88, but as shown in (b) of FIG. 14, a similar effect is achieved also in the case where a partition wall 272c is provided in a lower side of the third screw 88.

### Third Embodiment

Third Embodiment of the present invention will be described with reference to (a) and (b) of FIG. 15. In the above-described embodiments, the constitution in which the first and second wall members extended in the right (same) direction with respect to the feeding direction (rotational axis direction) of the third screw 88 was employed, but in this embodiment, a constitution in which the first and second wall members extend in right and left (different) directions is employed. Of the first and second wall members, the wall member close to an inner wall of the accommodating container has a constitution in which there is a gap between the wall member and the inner wall in the accommodating container at a downstream end portion.

In this embodiment, only a portion different from those in the above-described embodiments will be described by changing a reference numeral or symbol thereof, and materials and shapes of respective portions are similar to those in the above-described embodiments unless otherwise specified.

In FIG. 15, (a) and (b) are sectional views each showing a residual toner chamber 371b cut at the same position as that in (b) of FIG. 1. In (a) of FIG. 15, a plurality of partition walls 372c will be described as partition walls 372c1-372c5.

As shown in (a) and (b) of FIG. 15, the plurality of partition walls 372c for the residual toner chamber 371b are disposed in both (right and left) sides of the third screw 88 and are inclined toward the downstream side with respect to the arrow X direction with an increasing distance from the third screw 88. Further, the partition walls 372c are disposed alternately in the right and left sides with respect to the arrow X direction, and in the downstream side of the third screw 88, the partition wall 372c is disposed so as to extend from the same position of the screw shaft portion 88a toward the left and right sides while being inclined. In this embodiment, the residual toner chamber 371b is partitioned into 6 rooms by 5 partition walls 372c.

Further, as shown in (b) of FIG. 15, the residual toner chamber 371b is constituted by an upper cleaning frame surface 371t and a side cleaning frame surface 371u of the cleaning frame 371, and a lower cleaning cover surface 372t and a side cleaning cover surface 372u of the cleaning cover 372. Further, the partition wall 372c is provided with a packing preventing flow path 372d between the side cleaning frame surface 371u and the side cleaning cover surface 372u.

The toner fed in the arrow W direction by second screw 87 is delivered to the third screw 88 at a crossing portion between the second screw 87 and the third screw 88. The toner delivered to the third screw 88 is fed in the arrow X direction and abuts against the first partition wall 372c1.

The toner abutting against the first partition wall 372c1 moves along the first partition wall 372c1 and is fed in the Ri direction. The toner fed in the Ri direction is gradually accumulated in a first accommodating chamber 371b1 of the residual toner chamber 371b.

When the first accommodating chamber 371b1 is filled with the toner, the toner fed by the third screw 88 passes through a gap between the groove diameter l, provided by the first partition wall 372c1 and the upper partition wall 371x, and the diameter d1 of the screw shaft portion 88a, and is fed to a second accommodating chamber 371b2. The toner fed to the second accommodating container 371b2 is fed in the arrow X direction by the third screw 88 and then abuts against the second partition wall 372c2 inclined in an obliquely leftward direction (Le direction) with respect to the arrow X direction.

The toner abutted against the second partition wall 372c moves along the second partition wall 372c2 and is fed in the Le direction. The toner fed in the Le direction is gradually accumulated in the second accommodating container 371b2. Also in the third accommodating container 371b3 and later accommodating containers, the above-described relationship between the first accommodating container 371b1 and the second accommodating container 371b2 is reproduced. Further, when the toner abuts against the fifth partition wall 372c5 provided in the downstream side of the third screw 88, the toner is fed along the fifth partition wall 372c5 toward the left and right sides of the fifth accommodating container 371b5.

As described above, the toner fed by the third screw 88 is successively filled in the residual toner chamber 371b from an upstream space partitioned by the partition walls 372c. Further, the third screw 88 is provided with the partition walls 372c in the left and right (both) sides, compared with First Embodiment, the toner can be accumulated in every corner.

Accordingly, even when the process cartridge is increased in capacity and lifetime, it becomes possible to accommodate the toner efficiently and stably.

In this embodiment, in the residual toner chamber 371b, the partition walls 372c were disposed alternately in the right and left (both) sides of the third screw 88 with respect to the toner feeding direction of the third screw 88, but the partition walls 372c may also be disposed in the left and right (both) sides at the same position with respect to the feeding direction of the third screw 88.

In the case where a toner feeding amount per unit time is large or the toner excessively taken up moisture, the toner cannot be completely sent to the second accommodating container 371b2 through the gap between the groove diameter l provided by the first partition wall 372c1 and the upper partition wall 371x and the diameter d1 of the screw shaft portion 88a in some instances. In this case, the toner is fed to the first accommodating container 371b1. However, in this embodiment, in the case where the toner is excessively fed to the first accommodating container 371b1, the toner is caused to flow from the packing preventing flow path 372d into the second accommodating container 371b2.

Thus, in this embodiment, even in the case where the toner is excessively fed into each of the accommodating containers, the packing preventing flow path 372d is provided among the partition wall 372c, the side cleaning frame surface 371u and the side cleaning cover surface 372u, whereby the toner is prevented from being packed. For that reason, the toner can be accommodated stably without exerting an excessive load on the third screw which feeds the toner.

### MODIFIED EMBODIMENTS

Preferred embodiments of the present invention were described above, but the present invention is not limited thereto. Various modifications and changes of constitutions of the present invention are possible within the scope of the present invention. Incidentally, with respect to functions, materials, shapes and relative arrangement of constituent elements described in the above embodiments, the scope of the present invention is not intended to be limited only to these parameters.

### Modified Embodiment 1

The present invention having the constitutes relating to the accommodating containers described in the above-described embodiments is not limited to those for feeding the residual toner. For example, the present invention may also be used for feeding the developer in the developing device including a developer carrying member (developing roller) for carrying the developer to be supplied to the photosensitive drum as the image bearing member.

### Modified Embodiment 2

In the above-described embodiments, the accommodating container for feeding the developer is provided in the process cartridge insertable into the apparatus main assembly of the image forming apparatus, but may also be provided in an apparatus main assembly of an image forming apparatus in which the process cartridge is not used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-202501 filed on Oct. 14, 2015, which is hereby incorporated by reference herein in its entirety.

What is claimed is:

1. An accommodating container for accommodating a developer, comprising:
a feeding member for feeding the developer in said accommodating container; and
a wall member provided in said accommodating container and extending along a direction crossing a developer feeding direction of said feeding member and inclined so that a distance from said feeding member increases toward a downstream side of said feeding member with respect to the developer feeding direction.

2. An accommodating container according to claim 1, wherein said feeding member includes a rotation shaft and a helical blade, provided around said rotation shaft, for feeding the developer in the developer feeding direction.

3. An accommodating container according to claim 2, wherein said feeding member includes a region where said helical blade is provided around said rotation shaft and a region where only said rotation shaft is provided, and
wherein said wall member is provided along the direction crossing the developer feeding direction in the region where only said rotation shaft of said feeding member is provided.

4. An accommodating container according to claim 2, wherein said wall member is provided along the direction crossing the developer feeding direction in the region where said helical blade is provided around said rotation shaft.

5. An accommodating container according to claim 2, wherein said wall member is provided with a gap through which said rotation shaft penetrates.

6. An accommodating container according to claim 1, wherein said wall member is provided substantially in one side of said feeding member with respect to the developer feeding direction.

7. An accommodating container according to claim 1, wherein said wall member is provided in both sides of said feeding member with respect to the developer feeding direction.

8. An accommodating container according to claim 7, wherein said wall member includes a plurality of wall members provided alternately in one side and in the other side of the both sides toward the downstream side of said feeding member.

9. An accommodating container according to claim 7, wherein said wall member includes a plurality of members each including an upstream end portion at a position where said member crosses the developer feeding direction of said feeding member.

10. An accommodating container according to claim 1, wherein said wall member is provided with a gap from an inner wall of said accommodating container at a downstream end portion thereof with respect to the developer feeding direction.

11. A cleaning device comprising:
a collecting member for collecting a developer from an image bearing member; and
an accommodating container according to claim 1 for accommodating the developer collected by said collecting member at an accommodating portion where said accommodating container is provided.

12. A developing device comprising:
a developer carrying member for carrying a developer supplied to an image bearing member; and
an accommodating container device according to claim 1 for feeding the developer accommodated therein to said developer carrying member.

13. A process cartridge insertable into a main assembly of an image forming apparatus, comprising:
an image bearing member; and
an accommodating container according to claim 1.

14. A process cartridge insertable into a main assembly of an image forming apparatus, comprising:
an image bearing member; and
a cleaning device according to claim 11.

15. A process cartridge insertable into a main assembly of an image forming apparatus, comprising:
an image bearing member; and
a developing device according to claim 12.

16. An image forming apparatus comprising:
an image bearing member;
an accommodating container according to claim 1; and
an exposure device for forming an electrostatic latent image on said image bearing member,
wherein said image bearing member and said feeding device are provided in a process cartridge or in a main assembly of said image forming apparatus in which the process cartridge is not used.

17. An image forming apparatus comprising:
an image bearing member;
a cleaning device according to claim 11; and
an exposure device for forming an electrostatic latent image on said image bearing member,
wherein said image bearing member and said cleaning device are provided in a process cartridge or in a main assembly of said image forming apparatus in which the process cartridge is not used.

18. An image forming apparatus comprising:
an image bearing member;
a developing device according to claim 12; and
an exposure device for forming an electrostatic latent image on said image bearing member,
wherein said image bearing member and said developing device are provided in a process cartridge or in a main assembly of said image forming apparatus in which the process cartridge is not used.
